(19) United States
(12) Patent Application Publication
(10) Pub. No.: US 2014/0036874 A1
(43) Pub. Date: Feb. 6, 2014

(54) INTER-FREQUENCY/INTER-RAT CELL RESELECTION METHOD AND APPARATUS OF UE IN LTE MOBILE COMMUNICATION SYSTEM

(71) Applicant: Samsung Electronics Co. Ltd., Suwon-si (KR)

(72) Inventors: Kyeongin JEONG, Suwon-si (KR); Gert-Jan VAN LIESHOUT, Staines (GB)

(73) Assignee: Samsung Electronics Co. Ltd., Suwon-si (KR)

(21) Appl. No.: 13/956,810

(22) Filed: Aug. 1, 2013

(30) Foreign Application Priority Data
Aug. 1, 2012 (KR) 10-2012-0084605

(51) Int. Cl. H04W 36/30

(52) U.S. Cl. CPC H04W 36/30
USPC 370/332

(57) ABSTRACT

An inter-system cell selection method of a terminal in a mobile communication system is provided. The present disclosure may be embodied in the 3^{rd} Generation Partnership Program (3GPP) Long Term Evolution (LTE)/LTE-Advance (LTE-A) system as a mobile communication system. The cell reselection method of a terminal operating in idle mode includes receiving system information broadcast within a cell in performing measurement for cell reselection to a neighbor cell, determining whether the system information includes a movement condition threshold value, configuring at least one of a cell selection receive level and a cell selection quality as comparison criteria for cell reselection according to the determination result, and performing the cell reselection according to the comparison result.

### CROSS-REFERENCE TO RELATED APPLICATION(S)

This application claims the benefit under 35 U.S.C. §119(a) of a Korean patent application filed on Aug. 1, 2012 in the Korean Intellectual Property Office and assigned Serial No. 10-2012-0084605, the entire disclosure of which is hereby incorporated by reference.

### TECHNICAL FIELD

The present disclosure relates to a mobile communication system and, in particular, to an inter-frequency/inter-Radio Access Technology (RAT) cell selection/reselection method and apparatus of a User Equipment (UE) in a Long Term Evolution (LTE) system.

### BACKGROUND

Mobile communication systems developed to provide the subscribers with voice communication services on the move. With the rapid advance of technologies, the mobile communication systems have evolved to support high speed data communication services as well as the standard voice communication services. However, the resource shortage and user requirement for higher speed data services spurs the evolution of the mobile communication system to more advanced system.

Recently, as one of the next generation mobile communication systems, Long Term Evolution (LTE) is on the standardization by the 3^{rd} Generation Partnership Project (3GPP). LTE is a technology designed to provide high speed packet-based communication of up to 100 Megabits per second (Mbps) and aimed at commercial deployment. In order to accomplish the aim, a discussion is being held on several schemes: one scheme for reducing a number of nodes located in a communication path by simplifying a configuration of the network, and another scheme for maximally approximating wireless protocols to wireless channels.

In the conventional technology, when a User Equipment (UE) operating in Radio Resource Control (RRC) idle mode performs cell reselection to LTE neighbor frequency/neighbor Universal Terrestrial Radio Access Network (UTRAN) Frequency Division Duplex (FDD) frequency cell, if the serving cell and neighbor cell have different cell reselection configurations, the UE is likely to repeat the cell reselection back and forth between the serving and neighbor cells (a “Ping-Pong” effect).

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the abovementioned problems and/or disadvantages and to provide at least the advantages described below. Accordingly, an aspect of the present disclosure is to provide a cell selection/reselection method that is capable of selecting/reselecting a cell efficiently based on the cell selection receive level (Srxlev) and cell selection quality (Squal).

Another aspect of the present disclosure is to provide a cell selection/reselection method and apparatus for performing cell selection to a neighbor Long Term Evolution (LTE) frequency or Universal Mobile Telecommunications System (UMTS) Frequency Division Duplex (FDD) by taking notice of Squal too conditionally when Srxlev is configured as the cell reselection parameter by the legacy method, and of Srxlev too conditionally when Squal is configured as the cell reselection parameter by the legacy method.

In accordance with an aspect of the present disclosure, a cell reselection method of a terminal in idle mode in a mobile communication system is provided. The method includes receiving system information broadcast within a cell in performing measurement for cell reselection to a neighbor cell, determining whether the system information includes a movement condition threshold value, configuring at least one of a cell selection receive level and a cell selection quality as comparison criteria for cell reselection according to the determination result, and performing the cell reselection according to the comparison result.

In accordance with another aspect of the present disclosure, a terminal in idle mode for performing cell reselection in a mobile communication system is provided. The terminal includes a transceiver configured to receive system information broadcast within a cell, a channel measurement unit configured to measure a target channel, and a cell reselection determination and execution unit configure to determine whether the system information includes a movement condition threshold value, to configure at least one of a cell selection receive level and a cell selection quality as comparison criteria for cell reselection according to the determination result, and to perform cell reselection according to a comparison result.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating the architecture of a 3^{rd} Generation Partnership Project (3GPP) Long Term Evolution (LTE) system according to an embodiment of the present disclosure;

FIG. 2 is a flowchart illustrating a User Equipment (UE) cell selection procedure to LTE neighbor frequency/neighbor Universal Terrestrial Radio Access Network (UTRAN) Frequency Division Duplex (FDD) frequency in the 3GPP system according to an embodiment of the present disclosure;

FIG. 3 is a flowchart illustrating the UE cell selection procedure to the LTE neighbor frequency/neighbor UTRAN FDD frequency according to an embodiment of the present disclosure; and

FIG. 4 is a block diagram illustrating a configuration of the UE according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

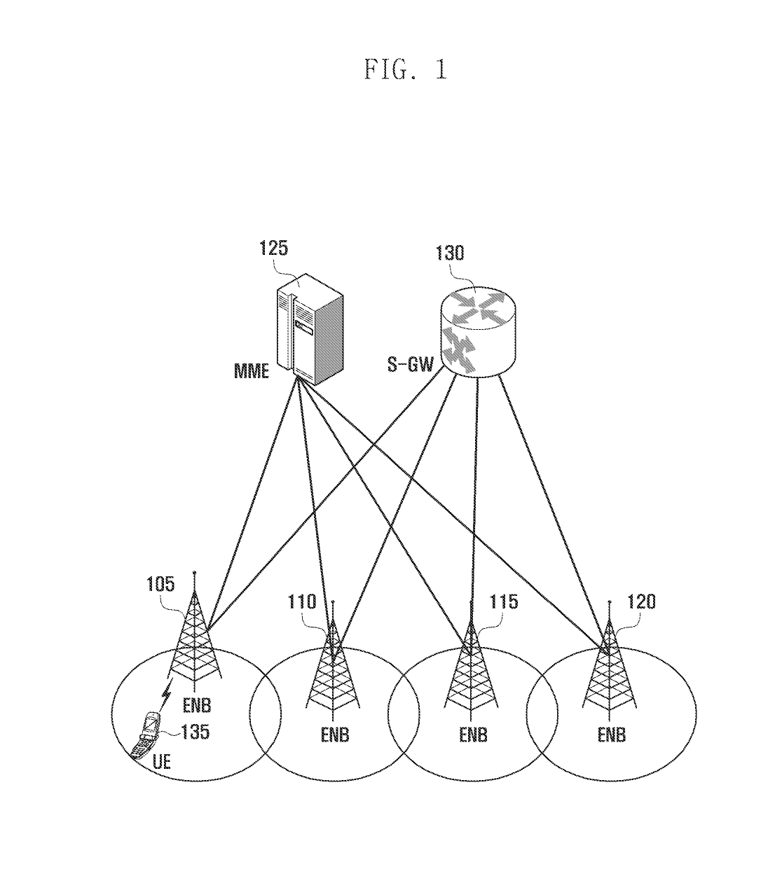

FIG. 1 is a diagram illustrating the architecture of a 3^{rd} Generation Partnership Project (3GPP) Long Term Evolution (LTE) system according to an embodiment of the present disclosure.

Referring to FIG. 1, the radio access network of the LTE system includes evolved Node Bs (eNBs) 105, 110, 115, and 120, a Mobility Management Entity (MME) 125, and a Serving-Gateway (S-GW) 130. The User Equipment (UE) 135 connects to an external network via eNBs 105, 110, 115, and 120 and the S-GW 130. The eNBs 105 to 120 correspond to the node B of the legacy Universal Mobile Telecommunications System (UMTS) system. The eNBs 105 to 120 allow the UE to establish a radio link and are responsible for complicated functions as compared to the legacy node B. In the LTE system, all the user traffic service including real time services such as Voice over Internet Protocol (VoIP) are provided through a shared channel, and thus there is a need of a device for scheduling data based on state information of the UEs, the eNBs 105 to 120 being responsible the data scheduling. In order to meet the data rate of up to 100 Megabits per second (Mbps), the LTE system adopts Orthogonal Frequency Division Multiplexing (OFDM) as a radio access technology. Also, the LTE system adopts Adaptive Modulation and Coding (AMC) to determine the modulation scheme and channel coding rate in adaptation to the channel condition of the UE. The AMC is a technique for determining the modulation scheme and channel coding rate for the channel condition. The S-GW 130 is an entity to provide data bearers so as to establish and release data bearers under the control of the MME 125. MME 125 is responsible for various control functions and connected to a plurality of eNBs 105 to 120.

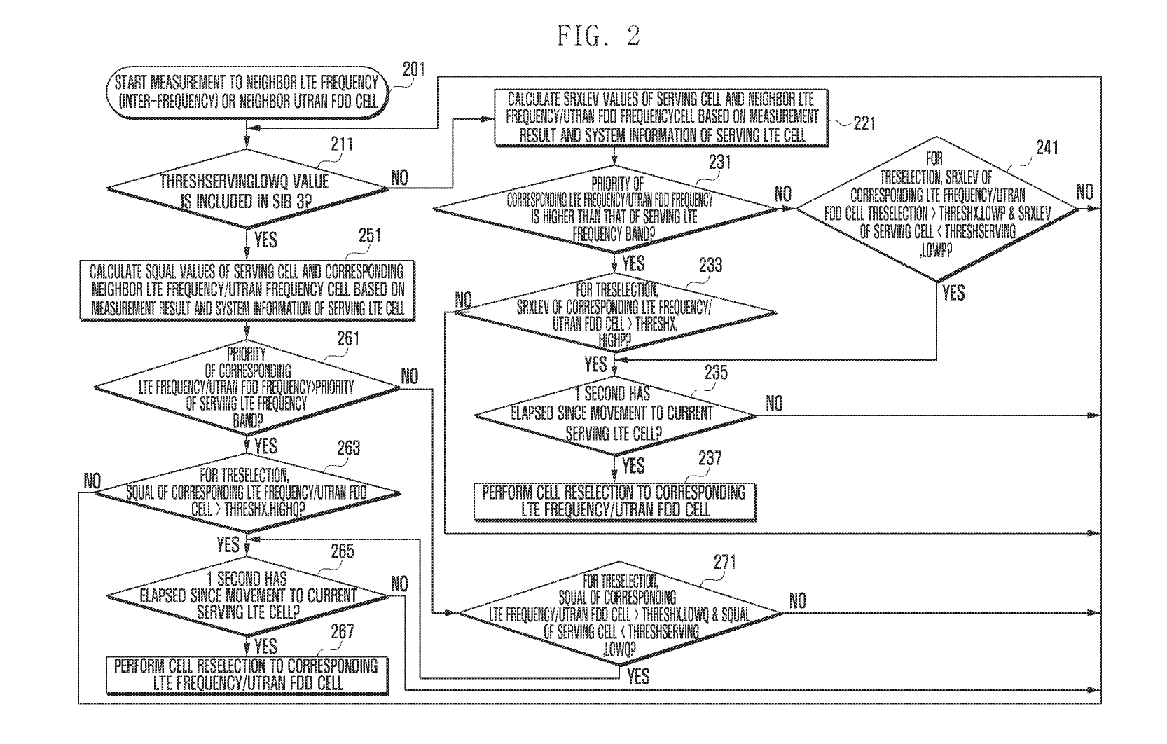

FIG. 2 is a flowchart illustrating a procedure of cell reselection of the UE operating in the Radio Resource Control (RRC) idle mode to an LTE neighbor frequency/neighbor Universal Terrestrial Radio Access Network (UTRAN) Frequency Division Duplex (FDD) frequency in the 3GPP system according to an embodiment of the present disclosure.

The UE operating in the RRC idle mode is the UE operating in a state having no RRC connection with a serving eNB. The UE operating in the RRC idle mode receives a common channel such as paging channel periodically, and selects an appropriate cell according to the channel condition to secure its mobility. The detailed operation of the UE in the idle mode follows the 3GPP standard TS36.304 “E-UTRA UE Procedures in idle mode.”

Referring to FIG. 2, the UE in the idle mode starts measurement for cell reselection to a neighbor LTE frequency/neighbor UTRAN FDD frequency (hereinafter, the term “cell reselection to a neighbor cell” is used interchangeably) at operation 201. The UE determines whether a System Information Block (SIB) 3 broadcast within the cell includes threshServingLowQ (hereinafter, the terminal ‘movement condition threshold value’ is used interchangeably) at operation 211. ThreshServingLowQ is a comparative threshold value signaled through SIB 3 for determining the channel state cell selection quality (Squal) of the current serving cell as a condition for switching to an LTE neighbor frequency or other system frequency having a priority lower than a priority of the current service frequency. Squal is described later in detail.

If the threshServingLowQ value is not signaled in SIB 3, the procedure goes to operation 221 and, otherwise if the threshServingLowQ value is signaled in SIB 3, it proceeds to operation 251.

If the threshServingLowQ value is not signaled (or not provided) in SIB 3, the UE calculates the cell selection receive level (Srxlev) value of the serving cell and the Srxlev value of the neighbor LTE frequency/UTRAN FDD frequency cell by applying the UE's measurement result and the system information broadcast by the serving LTE cell at operation 221.

The Srxlev denotes a Cell selection receive (RX) level value (cell selection reception level value (dB) is obtained by Equation (1)). Qrxlevmeas denotes the downlink reception power as the value obtained by measuring downlink RS channel at the UE, Qrxlevmin denotes a minim downlink reception power level required for selecting the corresponding cell, Qrxlevminoffset denotes the threshold value added to the Qrxlevmin on when the UE is in the Visited Public Land Mobile Network (PLMN) and searches for a PLMN having the highest priority periodically, and Pcompensation denotes the threshold value for taking the uplink channel state into consideration. The individual parameters are described in Table 1.

Srxlev=Qrxlevmeas−(Qrxlevmin+Qrxlevminoffset)−Pcompensation Equation (1)

TABLE 1

| Srxlev | Cell selection RX level value (dB) |
|---|---|
| Qᵣₓₗₑᵥₘₑₐₛ | Measured cell RX level value (RSRP) |
| Qᵣₓₗₑᵥₘᵢₙ | Minimum required RX level in the cell (dBm) |
| Q_{rxlevminoffset} | Offset to the signaled Qᵣₓₗₑᵥₘᵢₙ taken into account in the |
| | Srxlev evaluation as a result of a periodic search for a |
| | higher priority PLMN while camped normally in a |
| | VPLMN[5] |
| Pcompensation | max(P_{EMAX} − P_{PowerClass,} 0) (dB) |
| PEMAX | Maximum TX power level a UE may use when |
| | transmitting on the uplink in the cell (dBm) defined as |
| | P_{EMAX} in [TS 36.101] |
| P_{PowerClass} | Maximum RF output power of the UE (dBm) |
| | according to the UE power class as defined in [TS |
| | 36.101] |

Referring to Equation (1), Qrxlevmeas is acquired based on the Reference Signal Received Power (RSRP) for the serving LTE cell and neighbor LTE frequency cell and Received Signal Code Power (RSCP) for the neighbor UTRAN frequency cell. The RSRP is defined in the 3GPP standard TS36.214 “E-UTRA Physical Layer Measurements,” and the RSCP is defined in the 3GPP standard TS25.215 “Physical Layer-Measurements (FDD).”

Referring to Equation (1), the Qrxlevmin is set to the Q-RxLevMin value received in SIB 3 broadcast by the serving LTE cell for the serving LTE cell, the Q-RxLevMin value mapped to the corresponding frequency which is received in SIB 5 broadcast in the serving cell for the neighbor LTE frequency cell, and the q-RxLevMin value mapped to the corresponding frequency which is received in SIB 5 broadcast by the serving LTE cell.

Among the parameters used for calculating Srxlev, the Qrxlevmin can be set to distinct values per frequency per cell for Srxlev of the serving LTE cell, Srxlev of the neighbor LTE frequency cell, or Srxlev of the neighbor UTRAN FDD frequency cell.

The PEMAX applied for acquiring Pcompensation of Equation (1) denotes the maximum allowed UE output power which is configured by the eNB or Radio Network Controller (RNC) with the application of P-Max value received in SIB 3 for the serving LTE cell, P-Max power value received in SIB 5 for the neighbor LTE frequency cell, and P-Max power received in SIB 5 for the neighbor UTRAN FDD frequency cell. The PPowerClass denotes the nominal UE transmission power. The PPowerClass may have distinct values depending on the class of the UE.

After calculating Srxlev values of the serving and neighbor cells, the UE determines whether the priority of the measurement target neighbor LTE frequency/UTRAN FDD frequency is higher than that of the serving LTE frequency at operation 231. The priority information indicates the frequency to be considered with priority as the target of cell reselection and can be received through system information broadcast in the serving LTE cell or the UE-specific message (e.g., RRC Connection Release) in the RRC connected state.

If the priority of the measurement target neighbor LTE frequency/UTRAN FDD frequency is higher than that of the serving LTE frequency at operation 231, if the Srxlev value of the neighbor LTE frequency/UTRAN FDD frequency cell is greater than ThreshX,HighP value (or first threshold value) for the duration of Treselection timer (or cell reselection timer) at operation 233, and if the time of 1 second has elapsed since the movement to the current serving LTE cell at operation 235, the UE performs cell reselection to the corresponding neighbor LTE frequency/UTRAN FDD frequency cell at operation 237.

Here, the Treselection timer value, ThreshX,HighP Srxlev comparison threshold values are received in the system information broadcast by the serving LTE cell.

If the priority of the measurement target neighbor LTE frequency/UTRAN FDD frequency is not higher than (i.e., equal to less than) a priority of the serving LTE frequency at operation 231, if the Srxlev value of the neighbor LTE frequency/UTRAN FDD frequency cell is greater than the ThreshX,LowP (or second threshold value) and the Srxlev value of the current LTE frequency serving cell is less than the ThreshServing, LowP value (or, third threshold value) at operation 241, and if the time of 1 second has elapsed since the movement to the to the current serving LTE cell at operation 235, the UE performs cell reselection to the corresponding neighbor LTE frequency/UTRAN FDD frequency cell at operation 237.

Finally, if the above conditions are not fulfilled, the cell reselection to the neighbor LTE frequency/UTRAN FDD frequency does not occur.

Referring to operation 211 of FIG. 2, if the ThreshServingLowQ value (movement condition threshold value) is signaled (provided) in SIB 3 of the serving LTE cell at operation 211, the UE calculates Squal of the serving cell and Squal of the corresponding neighbor LTE frequency/UTRAN FDD frequency cell based on the measurement result and the system information broadcast in the serving cell at operation 251.

Here, Squal denotes the Cell selection quality value (dB) which is obtained by Equation (2). Qqualmeas denotes a ratio between the received signal strength measured on the downlink RS channel and the actually measured noise, Qqualmin denotes the minimum signal-to-noise ratio required for selecting the corresponding cell, Qqualminoffset denotes a threshold value added to the Qqualmin when the UE in the Vplmn and searches for the PLMN having higher priority periodically. The individual parameters are described in Table 2.

Squal=Qqualmeas−(Qqualmin+Qqualminoffset) Equation (2)

TABLE 2

| | |
|---|---|
| Squal | Cell selection quality value (dB) |
| Q_{qualmeas} | Measured cell quality value (RSRQ) |
| Q_{qualmin} | Minimum required quality level in the cell (dB) |
| Q_{qualminoffset} | Offset to the signaled Q_{qualmin} taken into account in the |
| | Squal evaluation as a result of a periodic search for a |
| | higher priority PLMN while camped normally in a |
| | VPLMN [5] |

The Qqualmeas values of the serving LTE cell and the neighbor LTE cell are obtained based on the Reference Signal Received Quality, and the Qqualmeas value of the neighbor UTRAN frequency cell is obtained based on Received Ec/No (RSCP/Received Signal Strength Indication (RSSI)). The Reference Signal Received Quality (RSRQ) is specified in the 3GPP standard TS36.214 “E-UTRA Physical Layer Measurements,” and the Ec/No is specified in the 3GPP standard TS25.215 “Physical Layer-Measurements (FDD).”

The Qqualmin for the serving LTE cell is obtained based on the Q-QualMin-r9 value received in the SIB 3 broadcast in the serving LTE cell, the Qqualmin for the neighbor LTE frequency cell is obtained based on the Q-QualMin-r9 mapped to the corresponding frequency received in SIB 5 broadcast in the serving LTE cell, and the Qqualmin for the neighbor UTRAN FDD frequency cell is acquired based on q-QualMin value mapped to the corresponding frequency received in SIB 6 broadcast in the serving LTE cell. That is, the Qqualmin has different values for the different frequencies when calculating Squal for the serving LTE cell, Squal for the neighbor LTE frequency cell, and Squal for the neighbor UTRAN FDD frequency cell.

After calculating the Squal values (cell selection quality value) for the serving and neighbor cells, the UE determines whether the priority of the serving LTE frequency is higher than a priority of the measurement target neighbor LTE frequency/UTRAN FDD frequency at operation 261. The priority information indicates the frequency to be considered with priority as the target of cell reselection and can be received through system information broadcast in the serving LTE cell or the UE-specific message (e.g., RRC Connection Release) in the RRC connected state.

If the priority of the measurement target neighbor LTE frequency/UTRAN FDD frequency is higher than a priority of the current serving LTE frequency at operation 261, if the Squal value of the neighbor LTE frequency/UTRAN FDD frequency is greater than ThreshX,HighQ value (or fourth threshold value) for the duration of Treselection timer (cell reselection timer) at operation 263, and if the time of 1 second has elapsed since the movement to the current serving LTE cell at operation 265, the UE performs cell reselection to the corresponding neighbor LTE frequency/UTRAN FDD frequency cell at operation 267.

Here, the Treselection timer value to be applied to the neighbor LTE frequency/UTRAN FDD frequency and the ThreshX,HighQ Squal comparison threshold value are received through the system information broadcast in the serving LTE cell.

Otherwise, if the priority of the measurement target neighbor LTE frequency/UTRAN FDD frequency is not greater than (i.e., equal to or less than) that of the current serving LTE frequency at operation 261, if the Squal value of the neighbor LTE frequency/UTRAN FDD frequency is greater than ThreshX,HighQ value (or fifth threshold value) for the duration of Treselection timer (cell reselection timer) and the Squal value of the current LTE frequency serving cell is less than ThreshServing,LowQ value (or sixth threshold value) at operation 271, and if the time of 1 second has elapsed since the movement to the current serving LTE cell at operation 265, the UE performs cell reselection to the corresponding neighbor LTE frequency/UTRAN FDD frequency cell at operation 267. If the above conditions are not fulfilled, the cell reselection to the neighbor LTE frequency/UTRAN FDD frequency does not occur.

In the case of performing the cell reselection to the neighbor LTE frequency/UTRAN FDD frequency cell through the procedure of FIG. 2, one of the Srxlev (cell selection received signal level value) and Squal (movement condition threshold value) is calculated depending on whether the ThreshServingLowQ is signaled/provided in SIB 3 and compared with the comparison threshold value received in the system information to perform the cell reselection based on the comparison result.

For example, in the state that the cell reselection has been performed to the neighbor LTE frequency/UTRAN FDD frequency based on the Srxlev (Srxlev value of the neighbor LTE frequency/UTRAN FDD frequency is high), if the Squal is set as the criterion for determining cell reselection for the reselected LTE frequency/UTRAN FDD frequency and if the Squal for the reselected LTE frequency/UTRAN FDD frequency is not as high as Srxlev value, this may cause a Ping-Pong effect in which the cell reselection occurs repeatedly back to the previous LTE frequency. The present disclosure provides a solution this problem using the parameters received in the legacy system information maximally while ruling out or minimizing extra signaling as far as possible.

In order to solve the above problem, the cell reselection method of the present disclosure sets at least one of the cell selection received signal level (Srxlev) and the cell selection quality (Squal) as the criterion for determining the cell reselection such that the UE is capable of performing cell selection/reselection procedure efficiently.

Unlike the conventional technology in which one of the Srxlev and Squal is set as the criterion for cell reselection depending on whether ThreshServingLowQ is signaled/provided in SIB 3, the cell reselection method according to an embodiment of the present disclosure may set both the Srxlev and Squal as the criteria for cell reselection determination according to the situation. In more detail, the cell reselection method according to an embodiment of the present disclosure performs, when the Srxlev is set as the cell reselection criterion according to the legacy method, conditional determination on the Squal additionally and, when the Squal is set as the cell reselection criterion according to the legacy method, conditional determination on the Srxlev additionally.

The UE located in the serving LTE cell receives the system information including the information on the neighbor LTE frequency and neighbor UTRAN FDD frequency. In this case, the neighbor LTE frequency information is received in the System Information Block (SIB) 5, and the UTRAN FDD frequency information is received in the SIB 6.

Then the UE calculates Srxlev of the corresponding frequency by applying Q-RxLevMin and P-Max information value per neighbor LTE frequency that are received in SIB 5 to Equation (1). The UE also calculates Squal of the corresponding frequency by applying Q-QualMin-r9 to Equation (2). The UE also calculates Srxlev of the corresponding frequency by applying q-RxLevMin and p-MaxUTRA information values per neighbor UTRAN FDD frequency which are received in SIB 6 to Equation (1) and Squal of the corresponding frequency by applying Q-QualMin-r9 information value to Equation (2).

In the following description on an embodiment of the present disclosure, if Squal>0, this means that Squal as the cell selection suitability check criteria (S criteria) is checked to determine whether it is fulfilled. Otherwise, if Srxlev>0, this means that Srxlev as the cell selection suitability check criteria (S criteria) to determine whether Srxlev is fulfilled. If Srxlev>0 and Squal>0, this means that both the Srxlev and Squal as the cell selection suitability check criteria (S criteria) are checked to determine whether they are fulfilled.

Case 1) when ThreshServingLowQ is not Provided/Signaled in SIB 3: (in this Case, Squal is Considered as an Additional Factor of the UE's Cell Selection Criteria)

Case 1_A): It is intended that the cell reselection to the neighbor LTE frequency/UTRAN FDD frequency having a priority higher than a priority of the current serving LTE frequency is performed when the channel state of the neighbor LTE frequency/UTRAN FDD frequency is higher, and the cell reselection to the neighbor LTE frequency/UTRAN FDD frequency having the priority lower than the priority of the current serving LTE frequency is performed even when the channel state of the neighbor LTE frequency/UTRAN FDD frequency is low:

Parameter setting of eNB: set Q-Qa1Min-r9 (for neighbor LTE frequency)/q-QualMin (for neighbor UTRAN FDD frequency) to a value high. However, Q-RxLevMin (for neighbor LTE frequency)/q-RxLevMin (for neighbor UTRAN FDD frequency) may be set to a value low. In this case, ThreshX.HighP may be set to a value high and ThreshX.LowP may be set to a value high.

UE operation: i) when the priority of the corresponding frequency is higher than that of the serving LTE frequency: in this case, the UE calculates Squal as well as Srxlev, checks whether Squal>0 condition is fulfilled as well as Srxlev>ThreshX,HighP condition is for Treselection timer duration with the simultaneous Srxlev and Squal comparisons and performs the cell reselection to the corresponding frequency only when the actually measured Qqualmeas value (like Qrxlevmeas) has a value high.

ii) When the priority of the corresponding frequency is lower than the priority of the serving LTE frequency: the UE calculates Srxlev as in the legacy technology and checks the Srxlev>ThreshX,LowP for the corresponding neighbor frequency and Srxlev<ThreshServing,Low P conditions for the duration of Treselection Timer to determine whether to perform cell reselection to the corresponding frequency.

In summary, the UE adds Squal as the comparison factor when performing cell reselection to the neighbor LTE frequency/UTRAN FDD frequency having the priority higher than the priority of the current serving LTE frequency and checks whether Squal>0 condition is fulfilled in Case 1_A.

Case 1_B): It is intended that the cell reselection to the neighbor LTE frequency/UTRAN FDD frequency having the priority higher than the priority of the current serving LTE frequency is performed even when the channel state of the neighbor LTE frequency/UTRAN FDD frequency is low and the cell reselection to the neighbor LTE frequency/UTRAN FDD frequency having the priority lower than the priority of the current serving LTE frequency is performed when the channel state of the neighbor LTE frequency/UTRAN FDD frequency is high:

eNB configuration: Q-QalMin-r9 (for neighbor LTE frequency)/q-QualMin (for neighbor UTRAN FDD frequency) is set to a high value. However, Q-RxLevMin (for neighbor LTE frequency)/q-RxLevMin (for neighbor UTRAN FDD frequency) may be set to a low value. In this case, the ThreshX,HighP is set to a low value and ThreshX,LowP is set to a high value.

UE operation: i) when the priority of the corresponding frequency is higher than that of the serving LTE frequency: In this case, the UE calculates Srxlev according to the legacy method and checks Srxlev>ThreshX,High condition for Treselection timer duration to determine whether to perform the cell reselection to the corresponding frequency.

ii) when the priority of the corresponding frequency is lower than that of the serving LTE frequency: The UE calculates Squal as well as Srxlev and checks Squal>0 condition as well as Srxlev>ThreshX,LowP and Srxlev<ThreshServing,LowP conditions to perform Srxlev and Squal comparisons simultaneously such that the cell reselection to the corresponding frequency occurs when the actually measured Qqualmeas (like Qrxlevmeas) value is high.

In summary, the UE adds Squal as comparison factor when perform cell reselection to the neighbor LTE frequency/neighbor UTRAN FDD frequency having the priority lower than the priority of the current serving LTE frequency and determines whether Squal>0 condition is fulfilled in Case 1_B.

Case 1_C): It is intended that the cell reselection to the neighbor LTE frequency/neighbor UTRAN FDD frequency having the priority higher than the priority of the current serving LTE frequency is performed when the channel state of the neighbor LTE frequency/neighbor UTRAN FDD frequency is high and the cell reselection to the neighbor LTE frequency/neighbor UTRAN FDD frequency having the priority lower than the priority of the current serving LTE frequency is performed when the channel state of the neighbor LTE frequency/neighbor UTRAN FDD frequency is high, or it is intended that the cell reselection to the neighbor LTE frequency/neighbor UTRAN FDD frequency having the priority higher than the priority of the current serving LTE frequency is performed when the channel state of the neighbor LTE frequency/neighbor UTRAN FDD frequency is low and the cell reselection to the neighbor LTE frequency/neighbor UTRAN FDD frequency having the priority lower than the priority of the current serving LTE frequency is performed when the channel state of the neighbor LTE frequency/neighbor UTRAN FDD frequency is low.

eNB's parameter setting:

i) The former case of Case 1_C:

Q-QualMin-r9 (for neighbor LTE frequency)/q-QualMin (for neighbor UTRAN FDD frequency) is set to a value high. In this case, ThreshX,HighP and ThreshX,LowP of the corresponding frequency are set to high values.

ii) The latter case of Case 1_C:

Q-QualMin-r9 (for neighbor LTE frequency)/q-QualMin (for neighbor UTRAN FDD frequency) is set to a low value. However, Q-RxLevMin (for neighbor LTE frequency)/q-RxLevMin (for neighbor UTRAN FDD frequency) may be set to a low value, too. In this case, ThreshX,HighP and ThreshX,LowP of the corresponding frequency are set to low values.

UE operation: i) when the priority of the corresponding frequency is higher than the priority of the serving LTE frequency: the UE calculates Squal as well as Srxlev and performs cell reselection to the corresponding frequency cell when Squal>0 condition is fulfilled as well as Srxlev>ThreshX,HighP condition for Treselection timer duration. ii) when the priority of the corresponding frequency is lower than the priority of the serving LTE frequency: the UE calculates Squal as well as Srxlev and performs cell reselection to the corresponding frequency cell when Squal>0 condition is fulfilled as well as the Srxlev>ThreshX,LowP for the corresponding neighbor frequency and Srxlev<ThreshServing,LowP conditions for the Treselection timer duration.

In summary, the UE uses Squal as an additional comparison factor when the cell reselection is performed to the neighbor LTE frequency/neighbor UTRAN FDD frequency having the priority higher or lower than the priority of the current serving LTE frequency, i.e., in all cases, and checks whether Squal>0 condition is fulfilled in Case 1_C.

Case 2) when ThreshServingLowQ is Provided/Signaled in SIB 3: (in this Case, Srxlev is Considered as an Additional Factor of the UE's Cell Selection Criteria)

Case 2_A): it is intended that the cell reselection to the neighbor LTE frequency/neighbor UTRAN FDD frequency having the priority higher than the priority of the current serving LTE frequency is performed when the channel state of the neighbor LTE frequency/neighbor UTRAN FDD frequency is high and the cell reselection to the neighbor LTE frequency/neighbor UTRAN FDD frequency having the priority lower than the priority of the current serving LTE frequency is performed even when the channel state of the neighbor LTE frequency/neighbor UTRAN FDD frequency is low.

eNB parameter setting: Q-RxLevMin (for neighbor LTE frequency)/q-RxLevMin (for neighbor UTRAN FDD frequency) is set to a high value. However, Q-QualMin-r9 (for neighbor LTE frequency)/q-QualMin (for neighbor UTRAN FDD frequency) may be set to a low value. In this case, ThreshX,HighQ of the corresponding frequency is set to a high value and ThreshX,LowQ is set to a low value.

UE operation: i) when the priority of the corresponding frequency is higher than the priority of the serving LTE frequency: in this case, the UE calculates Srxlev as well as Squal and checks whether the Srxlev>0 condition is fulfilled as well as Squal>ThreshX,HighQ condition for Treselection timer duration such that Squal and Srxlev comparisons are performed simultaneously to perform the cell reselection to the corresponding frequency when Qrxlevmeas (like Qqualmeas) actually measured on the corresponding frequency has a high value too. ii) When the priority of the corresponding frequency is lower than the priority of the serving LTE frequency: the UE calculates Squal according to the legacy technology and checks Squal>ThreshX,LowQ for the corresponding neighbor frequency and Srxlev<ThreshServing,LowQ condition for the serving LTE frequency to perform the cell reselection when these conditions are fulfilled.

In summary, the UE adds Srxlev as the comparison factor when performing cell reselection to the neighbor LTE frequency/neighbor UTRAN FDD frequency having the priority higher than the priority of the current serving LTE frequency and checks whether Srxlev>0 condition is fulfilled in Case 2_A.

Case 2_B): It is intended that the cell reselection to the neighbor LTE frequency/neighbor UTRAN FDD frequency having the priority higher than the priority of the current serving LTE frequency is performed even when the channel state of the neighbor LTE frequency/neighbor UTRAN FDD frequency is low and the cell reselection to the neighbor LTE frequency/neighbor UTRAN FDD frequency having the priority lower than the priority of the current serving LTE frequency is performed when the channel state of the neighbor LTE frequency/neighbor UTRAN FDD frequency is high.

eNB parameter setting: Q-RxLevMin (for neighbor LTE frequency)/q-RxLevMin (for neighbor UTRAN FDD frequency) is set to a high value. However, Q-QualMin-r9 (for neighbor LTE frequency)/q-QualMin (for neighbor UTRAN FDD frequency) may be set to a low value. In this case, ThreshX,HighQ of the corresponding frequency is set to a low value and Q-QualMin=r9 is set to a high value.

UE operation: i) when the priority of the corresponding frequency is higher than the priority of the serving LTE frequency: the UE calculates Squal according to the legacy technology and checks Squal>ThreshX,HighQ condition of the corresponding neighbor frequency for Treselection timer duration to determine whether to perform cell reselection to the corresponding frequency. ii) when the priority of the corresponding frequency is less than the priority of the serving LTE frequency: the UE calculates Srxlev as well as Squal and checks whether Srxlev>0 condition is fulfilled as well as Squal>ThreshX,LowQ condition for the neighbor frequency and Squal<ThreshServing,LowQ for the corresponding neighbor frequency for the Treselection timer duration such that Squal and Srxlev comparisons are performed simultaneously to perform the cell reselection to the corresponding frequency when the Qrxlevmeas measured actually to the corresponding frequency (like Qqualmeas) has a high value.

In summary, the UE adds Srxlev as the comparison factor when performing cell reselection to the neighbor to the neighbor LTE frequency/neighbor UTRAN FDD frequency having the priority lower than the priority of the current serving LTE frequency and checks whether Srxlev>0 condition is fulfilled in Case2B.

Case 2_C): It is intended that the cell reselection to the neighbor LTE frequency/neighbor UTRAN FDD frequency having the priority higher than the priority of the current serving LTE frequency is performed when the channel state of the neighbor LTE frequency/neighbor UTRAN FDD frequency is high and the cell reselection to the neighbor LTE frequency/neighbor UTRAN FDD frequency having the priority lower than the priority of the current serving LTE frequency is performed too when the channel state of the neighbor LTE frequency/neighbor UTRAN FDD frequency is high: Or it is intended that the cell reselection to the neighbor LTE frequency/neighbor UTRAN FDD frequency having the priority higher than the priority of the current serving LTE frequency is performed even when the channel state of the neighbor LTE frequency/neighbor UTRAN FDD frequency is low and the cell reselection to the neighbor LTE frequency/neighbor UTRAN FDD frequency having the priority lower than the priority of the current serving LTE frequency is performed when the channel state of the neighbor LTE frequency/neighbor UTRAN FDD frequency is low.

eNB parameter setting:

The former case of Case 2_C

Q-RxLevMin (for neighbor LTE frequency)/q-RxLevMin (for neighbor UTRAN FDD frequency) is set to a high value. However, Q-QualMin-r9 (for neighbor LTE frequency)/q-QualMin (for neighbor UTRAN FDD frequency) is set to a low value. In this case, ThreshX,HighQ and ThreshX,LowQ for the corresponding frequency are set to a high value.

The latter case of Case 2_C

Q-RxLevMin (for neighbor LTE frequency)/q-RxLevMin (for neighbor UTRAN FDD frequency) is set to a low value. However, Q-QualMin-r9 (for neighbor LTE frequency)/q-QualMin (for neighbor UTRAN FDD frequency) is set to a low value. In this case, ThreshX,HighQ and ThreshX,LowQ for the corresponding frequency are set to a low value.

UE operation: i) When the priority of the corresponding frequency is higher than the priority of the serving LTE frequency: The UE calculates Srxlev as well as Squal and performs the cell reselection to the corresponding frequency when Srxlev>0 condition is fulfilled as well as Squal>ThreshX,HighQ condition for Treselection timer duration. ii) When the priority of the corresponding frequency is lower than the priority of the serving LTE frequency: The UE calculates Srxlev as well as Squal and performs the cell reselection to the corresponding cell when the Srxlev>0 condition is fulfilled as well as the Squal>ThreshX,LowQ for the corresponding neighbor frequency and Squal<ThreshServing,LowQ condition for the serving LTE frequency.

In summary, the UE uses Srxlev as an additional comparison factor when the cell reselection is performed to the neighbor LTE frequency/neighbor UTRAN FDD frequency having the priority different from the priority of the current serving LTE frequency, i.e., in all cases, and checks whether Srxlev>0 condition is fulfilled in Case 2_C.

The above description can be summarized from the UE's viewpoint as follows.

The situation can be classified into one of case 1 and case 2 according to whether ThreshServingLowQ (movement condition threshold value) is provided in SIB 3. The additional factor to be considered in UE's cell selection is determined depending on whether the situation is Case 1 or Case 2.

Squal is the factor to be additionally considered in UE's cell selection in case 1, and Srxlev is the factor to be additionally considered in UE's cell section in case 2.

Each case is further classified into cases A, B, and C according to the additional factor to be considered in the cell selection process.

For example, case A is characterized in that an additional factor is considered in performing cell reselection to the neighbor LTE frequency/neighbor UTRAN FDD frequency having the priority higher than the priority of the current serving LTE frequency. Next, case B is characterized in that an additional factor is considered in performing the cell reselection to the neighbor LTE frequency/neighbor UTRAN FDD frequency having the priority lower than the priority of the current serving LTE frequency. Finally, case C is characterized in that an additional factor is considered in performing cell reselection to the neighbor LTE frequency/neighbor UTRAN FDD frequency having the priority different from the priority of the current serving LTE frequency (i.e., regardless of the priority).

Hereinabove, descriptions have been made on case 1 and case 2 and sub-cases A, B, and C per case. In the standard, the UE operation is defined fixedly under the assumption that one of Case x_A (x=1 & 2), Case x_B, Case x_C is the typical case (in this case, the UE operates in Case 1_A+Case 2_A, Case 1_B+Case 2_B, or Case 1_C+Case 2_C specified in the standard), or the case configured with the eNB is signaled to the UE (e.g., the eNB instructs the UE to operate in Case 1_A+Case 2_A, Case 1_B+Case 2_B, or Case 1_C+Case 2_C using a bitmap or integer value in the system information broadcast. It is not ruled out to use a value indicating the operations in Case 1_A+Case 2_B and Case 1_B+Case 2_A) such chat the UE performs the operation according to the signaled case.

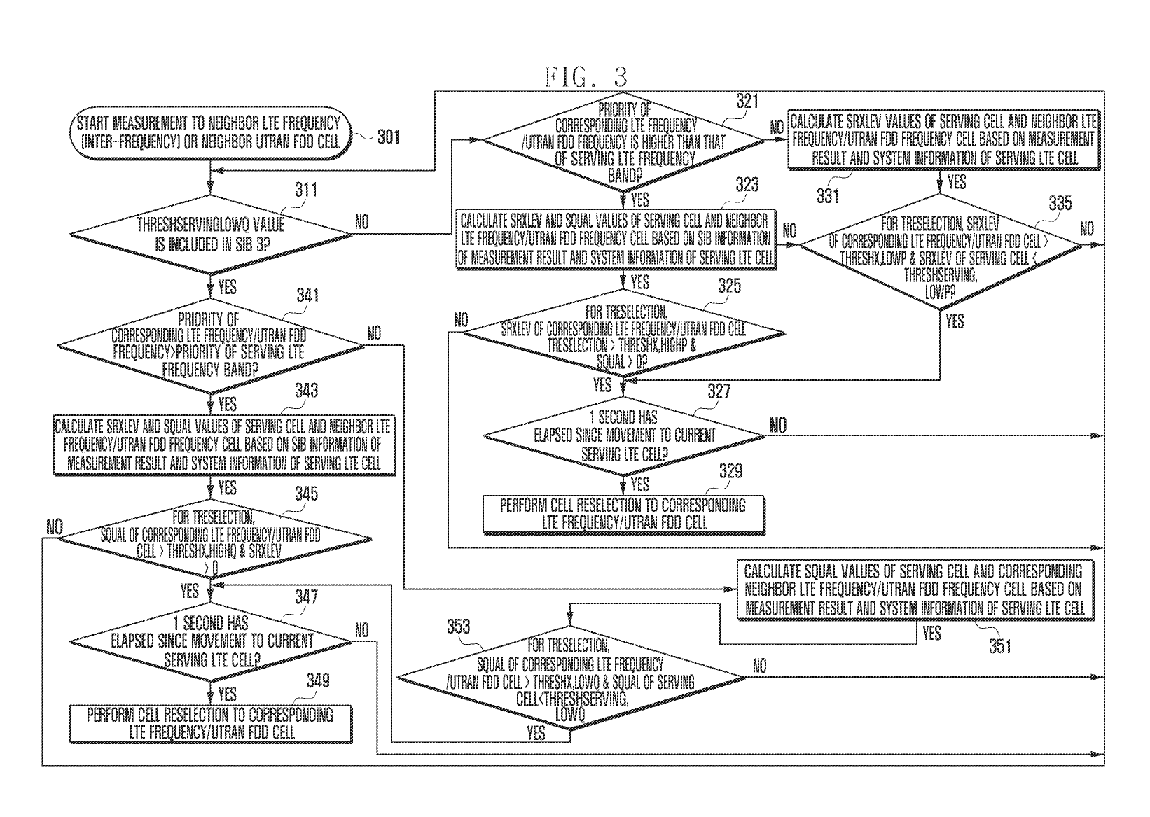

FIG. 3 is a flowchart illustrating the UE procedure when Case 1_A+Case 2_A is assumed as the typical network case according to an embodiment of the present disclosure.

Although FIG. 3 is directed to the UE operations under the assumption of Case 1_A+Case 2_A, the UE is also capable of operating in the situation Case 1_B+Case 2_B or Case 1_C+Case 2_C as described above without departing from the principle of the present disclosure.

FIG. 3 shows s cell reselection method of the UE operating in RRC idle mode to the neighbor LTE frequency/frequency in the 3GPP system.

The UE in LTE idle mode starts measurement for cell reselection to the neighbor LTE frequency/neighbor UTRAN FDD frequency at operation 301 and determines whether the SIB 3 broadcast in the cell includes ThreshServingLowQ (movement condition threshold value) at operation 311.

ThreshServingLowQ is the threshold value signaled in SIB 3 for use in determining the channel state Squal of the current serving cell as a condition to move to the LTE neighbor frequency or other system frequency having the priority lower than the priority of the current serving frequency.

If the threshServingLowQ is not signaled/provided in SIB 3 at operation 311 and if the priority of the neighbor LTE frequency/neighbor UTRAN frequency is higher than the priority of the serving LTE frequency at operation 321, the UE calculates Srxlev and Squal of the serving cell and Srxlev and Squal of the corresponding neighbor LTE frequency/neighbor UTRAN FDD frequency cell by applying the measurement result and the system information broadcast in the serving LTE cell at operation 323. Since the equations for obtaining Srxlev and Squal and parameters input to the equations have been described with reference with reference to FIG. 2, detailed descriptions thereof are omitted herein.

If Srxlev of the neighbor LTE frequency/neighbor UTRAN FDD frequency cell is greater than ThreshX,HighP for Treselection timer duration and Squal is greater than 0 at operation 325 and if the time of 1 second has elapsed since the movement to the correspond neighbor LTE frequency/neighbor UTRAN FDD frequency cell at operation 327, the UE performs cell reselection to the corresponding neighbor LTE frequency/neighbor UTRAN FDD frequency cell at operation 329.

If the priority of the measurement target neighbor LTE frequency/neighbor UTRAN FDD frequency is not higher than (i.e., is equal to or lower than) the priority of the current serving LTE frequency at operation 321, the UE calculates Srxlev of the serving cell and Srxlev of the corresponding neighbor LTE frequency/neighbor UTRAN FDD frequency cell based on the measurement result and the system information broadcast in the serving LTE cell at operation 331.

If Srxlev of the neighbor LTE frequency/neighbor UTRAN FDD frequency cell is greater than ThreshX,LowP for the Treselection timer duration and Srxlev of the serving cell of the current LTE frequency is less than ThreshServing,LowP at s operation 335 and if the time of 1 second has elapsed since the movement to the current serving LTE cell at operation 327, the UE performs cell reselection to the corresponding neighbor LTE frequency/neighbor UTRAN FDD frequency cell at operation 329.

The procedure returns to operation 311 of FIG. 3. If ThreshServingLowQ is signaled/provided in SIB 3 of the serving LTE cell at operation 311 and if the priority of the corresponding neighbor LTE frequency/neighbor UTRAN frequency is higher than the priority of the serving LTE frequency at operation 341, the UE calculates Srxlev and Squal values for both the serving cell and corresponding neighbor LTE frequency/neighbor UTRAN FDD frequency cell based on the measurement result and the system information broadcast in the serving LTE cell at operation 343.

Since the equations for calculating Srxlev and Squal and parameters input to the equations have been described with reference to FIG. 2, detailed descriptions thereof are omitted.

If Squal of the neighbor LTE frequency/neighbor UTRAN FDD frequency cell is greater than ThreshX,HighQ for Treselection timer duration and Srxlev is greater than 0 at operation 345 and if the time of 1 second has elapsed since the movement to the current serving LTE cell at operation 347, the UE performs cell reselection to the corresponding neighbor LTE frequency/neighbor UTRAN FDD frequency cell at operation 349.

Otherwise, if the priority of the measurement target neighbor LTE frequency/neighbor UTRAN FDD frequency is not higher than (i.e., equal to or lower than) the priority of the current serving LTE frequency at operation 341, the UE calculates Squal values of the serving cell and the corresponding neighbor LTE frequency/neighbor UTRAN FDD frequency cell based on the measurement result and the system information broadcast in the serving cell at operation 351.

If the Squal value of the neighbor LTE frequency/neighbor UTRAN FDD frequency cell is greater than ThreshX,LowQ and the Squal value of the current LTE frequency serving cell is less than ThreshServing,LowQ at operation 353 and if the time of 1 second has elapsed since the movement to the current serving LTE cell at operation 347, the UE performs cell reselection to the corresponding neighbor LTE frequency/neighbor UTRAN FDD frequency cell at operations 349. If the above conditions are not fulfilled, the cell reselection to the neighbor LTE frequency/neighbor UTRAN FDD frequency does not occur.

Although not depicted in FIG. 3, if it operates in the Case 1_B+Case 2_B mode, the UE calculates Srxlev values of the serving cell and the corresponding neighbor LTE frequency/neighbor UTRAN FDD frequency cell based on the measurement result and the system information broadcast in the serving LTE cell at operation 323, calculates Srxlev and Squal values of the serving cell and the corresponding neighbor LTE frequency/neighbor UTRAN FDD frequency cell based on the measurement result and the system information broadcast in the serving LTE cell at operation 331, and adds the Srxlev>0 check condition at operation 335.

The UE calculates Squal values of the serving cell and the neighbor LTE frequency/neighbor UTRAN FDD frequency cell based on the measurement result and the system information broadcast in the serving LTE cell at operation 343, calculates Srxlev and Squal values of the serving cell and the corresponding neighbor LTE frequency/neighbor UTRAN FDD frequency cell based on the measurement result and the system information broadcast in the serving LTE cell at operation 351, and adds the Srxlev>0 check condition at operation 353.

Meanwhile, if it operates in the Case 1_C+Case 2_C mode, the UE calculates Srxlev and Squal values of the serving LTE cell and the corresponding neighbor LTE frequency/neighbor UTRAN FDD frequency cell based on the measurement result and the system information broadcast in the serving LTE cell at operation 331 and adds the Srxlev>0 check condition at operation 335. The UE calculates Srxlev and Squal values of the serving cell and the corresponding neighbor LTE frequency/neighbor UTRAN FDD frequency cell based on the measurement result and the system information broadcast in the serving LTE cell at operation 351 and adds the Srxlev>0 check condition at operation 353.

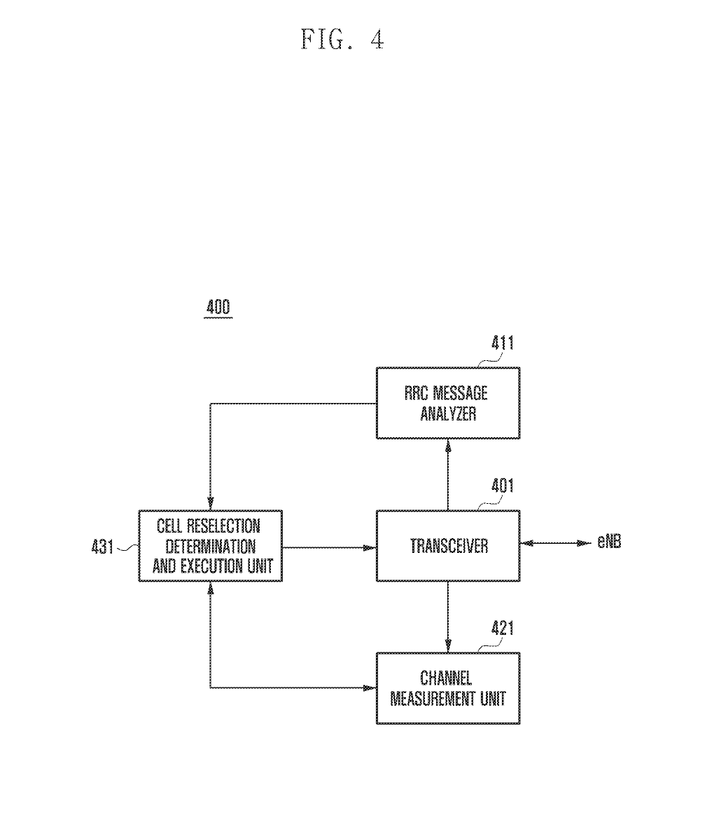

FIG. 4 is a block diagram illustrating a configuration of the UE 400 according to an embodiment of the present disclosure. The UE receives the system information broadcast by an eNB within the serving LTE cell or measurement target channel (e.g., Common reference Signal (CRS)) by means of the transceiver 401.

The system information received by means of the transceiver 401 is analyzed by the RRC message analyzer 411 to acquire the parameters associated with the present disclosure.

The channel measurement unit 421 performs measurement on the target channel (e.g., Qrxlevmeas and/or Qqualmeas), calculates Srxlev and/or Squal values of the serving LTE cell and the corresponding neighbor LTE frequency/neighbor UTRAN FDD frequency cell based on the measurement result and received parameter value, and cell reselection determination and execution unit 431 compares the Srxlev and/or Squal values acquired through a method determined according to the priority of the current frequency to determine whether to perform cell reselection to the corresponding neighbor LTE frequency/neighbor UTRAN FDD frequency cell and perform the selection.

In more detail, the cell reselection determination and execution unit 431 checks whether the system information includes the movement condition threshold value and configures at least one of the cell selection receive level value and cell selection quality value acquired based on the measurement result performed according to the check result as a comparison factor for cell reselection. The cell reselection determination and execution unit 431 controls the UE to perform the cell reselection process.

In more detail, the cell reselection determination and execution unit 431 performs, if Srxlev is configured by the conventional method as the parameter for cell reselection, Squal condition fulfillment determination (i.e., Squal>0 is fulfilled) additionally and, otherwise if Squal is configured as the parameter for cell reselection, Srxlev condition fulfillment determination (i.e., Srxlev>0 is fulfilled) additionally.

In an embodiment of the present disclosure, if the system information includes no movement condition threshold value, the cell reselection determination and execution unit 431 configures the cell selection receive level value and cell selection quality value as the comparison criteria for cell reselection to the neighbor cell having the priority higher than the priority of the serving cell frequency.

Also, if the system information includes no movement condition threshold value, the cell reselection determination and execution unit 431 configures the cell selection receive level value and cell selection quality value as the comparison criteria for the cell reselection to the neighbor cell having the priority lower than the priority of the serving cell frequency.

Also, if the system information includes no movement condition threshold value, the cell reselection determination and execution unit 431 configures the cell selection receive level value and cell selection quality value as the comparison criteria for the cell reselection to the neighbor cell having the priority different from the priority of the serving cell frequency.

Also, if the system information includes the movement condition threshold value, the cell reselection determination and execution unit 431 configures the cell selection receive level value and cell selection quality value as the comparison criteria for the cell reselection to the neighbor cell having the priority higher than the priority of the serving cell frequency.

Also, if the system information includes the movement condition threshold value, the cell reselection determination and execution unit 431 configures the cell selection receive level value and cell selection quality value as the comparison criteria for the cell reselection to the neighbor cell having the priority lower than the priority of the serving cell frequency.

Also, if the system information includes the movement condition threshold value, the cell reselection determination and execution unit 431 configures the cell selection receive level value and cell selection quality value as the comparison criteria for the cell reselection to the neighbor cell having the priority different from the priority of the serving cell frequency.

As described above, the cell selection/reselection method of the present disclosure is capable of configuring at least one of the cell selection receive level (Srxlev) and cell selection quality (Squal) as cell selection/reselection criteria such that the UE is capable of performing cell selection/reselection efficiently without a Ping-Pong effect.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A cell reselection method of a terminal in idle mode in a mobile communication system, the method comprising:
receiving system information broadcast within a cell in performing measurement for cell reselection to a neighbor cell;
determining whether the system information includes a movement condition threshold value;
configuring at least one of a cell selection receive level and a cell selection quality as comparison criteria for cell reselection according to the determination result; and
performing the cell reselection according to the comparison result.

2. The method of claim 1, wherein the configuring comprises configuring, when the system information includes no movement condition threshold value, the cell selection receive level and cell selection quality as the comparison criteria for cell reselection to the neighbor cell having a priority higher than a priority of a serving cell frequency.

3. The method of claim 1, wherein the configuration comprises configuring, when the system information includes no movement condition threshold value, the cell selection receive level and cell selection quality as the comparison criteria for cell reselection to the neighbor cell having a priority lower than a priority of a serving cell frequency.

4. The method of claim 1, wherein the configuring comprises configuring, when the system information includes no movement condition threshold value, the cell selection receive level and cell selection quality as the comparison criteria for cell reselection to the neighbor cell having a priority different from a priority of a serving cell frequency.

5. The method of claim 1, wherein the configuring comprises configuring, when the system information includes the movement condition threshold value, the cell selection receive level and cell selection quality as the comparison criteria for cell reselection to the neighbor cell having a priority higher than a priority of a serving cell frequency.

6. The method of claim 1, wherein the configuring comprises configuring, when the system information includes the movement condition threshold value, the cell selection receive level and cell selection quality as the comparison criteria for cell reselection to the neighbor cell having a priority lower than a priority of a serving cell frequency.

7. The method of claim 1, wherein the configuring comprises configuring, when the system information includes the movement condition threshold value, the cell selection receive level and cell selection quality as the comparison criteria for cell reselection to the neighbor cell having a priority different from a priority of a serving cell frequency.

8. A terminal in idle mode for performing cell reselection in a mobile communication system, the terminal comprising:
a transceiver configured to receive system information broadcast within a cell;
a channel measurement unit configured to measure a target channel; and
a cell reselection determination and execution unit configured to determine whether the system information includes a movement condition threshold value, to configure at least one of a cell selection receive level and a cell selection quality as comparison criteria for cell reselection according to the determination result, and to perform cell reselection according to a comparison result.

9. The terminal of claim 8, wherein the cell reselection determination and execution unit configures, when the system information includes no movement condition threshold value, the cell selection receive level and cell selection quality as the comparison criteria for cell reselection to the neighbor cell having a priority higher than a priority of a serving cell frequency.

10. The terminal of claim 8, wherein the cell reselection determination and execution unit configures, when the system information includes no movement condition threshold value, the cell selection receive level and cell selection quality as the comparison criteria for cell reselection to the neighbor cell having a priority lower than a priority of a serving cell frequency.

11. The terminal of claim 8, wherein the cell reselection determination and execution unit configures, when the system information includes no movement condition threshold value, the cell selection receive level and cell selection quality as the comparison criteria for cell reselection to the neighbor cell having a priority different from a priority of a serving cell frequency.

12. The terminal of claim 8, wherein the cell reselection determination and execution unit configures, when the system information includes the movement condition threshold value, the cell selection receive level and cell selection quality as the comparison criteria for cell reselection to the neighbor cell having a priority higher than a priority of a serving cell frequency.

13. The terminal of claim 8, wherein the cell reselection determination and execution unit configures, when the system information includes the movement condition threshold value, the cell selection receive level and cell selection quality as the comparison criteria for cell reselection to the neighbor cell having a priority lower than a priority of a serving cell frequency.

14. The terminal of claim 8, wherein the cell reselection determination and execution unit configures, when the system information includes the movement condition threshold value, the cell selection receive level and cell selection quality as the comparison criteria for cell reselection to the neighbor cell having a priority different from a priority of a serving cell frequency.
